(19) United States
(12) Patent Application Publication
(10) Pub. No.: US 2017/0218904 A1
(43) Pub. Date: Aug. 3, 2017

(54) HIGH-PRESSURE PUMP

(71) Applicants: Tatsuro KOGA, Kariya-city (JP); Yutaka MIYAMOTO, Kariya-city (JP); Teppei MATSUMOTO, Kariya-city (JP)

(72) Inventors: Tatsuro KOGA, Kariya-city (JP); Yutaka MIYAMOTO, Kariya-city (JP); Teppei MATSUMOTO, Kariya-city (JP)

(73) Assignee: DENSO CORPORATION, Kariya-city, Aichi-pref. (JP)

(21) Appl. No.: 15/329,420

(22) PCT Filed: Nov. 26, 2015
(86) PCT No.: PCT/JP2015/005873

§ 371 Date: Jan. 26, 2017

(30) Foreign Application Priority Data
Dec. 5, 2014 (JP) 2014-247075

(51) Int. Cl. F02M 59/36; F02M 59/46; F04B 49/24; F02M 59/02; F04B 19/22; F04B 53/10

(52) U.S. Cl. CPC F02M 59/36; F04B 19/22; F04B 53/10; F04B 49/24; F02M 59/025; F02M 59/46; F04B 53/16

(57) ABSTRACT

A discharge valve of a high-pressure pump is placed in a discharge passage and is openable to enable flow of fuel from a pressurizing chamber to a discharge outlet in response to a fuel pressure difference between the pressurizing chamber side and the discharge outlet side. A relief is placed in a relief passage. The relief passage communicates between a branching portion, which is located on a side of the discharge valve where the discharge outlet is placed in the discharge passage, and a return portion, which merges with a damper chamber. The relief valve is openable to enable flow of the fuel from the branching portion to the return portion in response to a fuel pressure difference between the branching portion side and the return portion side. A discharge passage orifice is placed between the discharge valve and the branching portion in the discharge passage and constricts a flow passage cross-sectional area of the discharge passage.

### CROSS REFERENCE TO RELATED APPLICATION

The present application is based on and incorporates herein by reference Japanese Patent Application No. 2014-247075 filed on Dec. 5, 2014.

### TECHNICAL FIELD

The present disclosure relates to a high-pressure pump used at an engine.

### BACKGROUND ART

Previously, there is known a high-pressure pump that reciprocates a plunger to pressurize fuel received from a fuel tank and to discharge the pressurized fuel as high-pressure fuel to a fuel rail, to which a fuel injection valve is connected, in a fuel supply apparatus that supplies the fuel to an engine. One such high-high-pressure pump includes a relief valve that returns a portion of the discharged high-pressure fuel to a region located on an upstream side of a discharge valve when the fuel pressure of the fuel rail is increased beyond a predetermined value. For instance, in a pressure relief device disclosed in a patent literature 1, a relief valve is installed in a relief passage that is branched from a discharge passage located on a downstream side of a discharge valve, and a pulsation reducing means, which generates a gap flow by constricting a flow passage cross-sectional area, is formed on an upstream side of the relief valve in the relief passage. In this way, an influence of the pressure pulsation, which is generated in response to reciprocation of the plunger, on the relief valve is reduced.

The relief valve, which is installed in the high-pressure pump, is for releasing an excess pressure at the abnormal time, at which the fuel pressure of the fuel rail is increased beyond the predetermined value, and it is desirable that the relief valve is not opened during the normal operation time. Thus, in view of the pressure pulsation of the discharge passage, it is required to set a valve opening pressure of the relief valve to a high value to limit opening of the relief valve at a peak pressure of the pressure pulsation. However, when the valve opening pressure of the relief valve is set to the high value, a maximum pressure of the fuel rail until the time of valve opening the relief valve is increased for the amount that corresponds to the increase in the maximum pressure. Therefore, it is required to increase the valve opening pressure of the fuel injection valve, and it is also required to increase the pressure resistance of members used in the high-pressure region. With respect to the above point, in the device of the patent literature 1, the peak pressure of the pressure pulsation can be reduced by reducing the pressure pulsation applied to the relief valve, and thereby the set value of the valve opening pressure of the relief valve can be reduced. However, in the device of the patent literature 1, since the flow passage cross-sectional area on the upstream side of the relief valve is constricted, there is a disadvantage of that a sufficient relief flow rate of the fuel from the fuel rail cannot be ensured.

### CITATION LIST

### Patent Literature

PATENT LITERATURE 1: JP2004-197834A

### SUMMARY OF INVENTION

The present disclosure is made in view of the above points, and it is an objective of the present disclosure to provide a high-pressure pump that reduces a pressure pulsation exerted to a relief valve while a sufficient relief flow rate of fuel is ensured.

A high-pressure pump of the present disclosure includes a plunger, a cylinder, a discharge valve, a relief valve and a discharge passage orifice.

The cylinder reciprocatably receives the plunger and forms a pressurizing chamber, which faces one end of the plunger and pressurizes fuel.

The discharge valve is placed in a discharge passage, which communicates between the pressurizing chamber and a discharge outlet. The discharge valve is openable to enable flow of the fuel from the pressurizing chamber to the discharge outlet in response to a fuel pressure difference between the pressurizing chamber side and the discharge outlet side.

The relief valve is placed in a relief passage. The relief passage communicates between a branching portion, which is located on a side of the discharge valve where the discharge outlet is placed in the discharge passage, and a return portion, which merges with a fuel chamber at a location that is on an upstream side of the discharge valve with respect to a flow of the fuel. The relief valve is openable to enable flow of the fuel from the branching portion to the return portion in response to a fuel pressure difference between the branching portion side and the return portion side. Here, it should be noted that the fuel chamber, to which the return portion merges, include a space, which accumulates the fuel, or a space (passage), in which the fuel flows.

The discharge passage orifice is placed between the discharge valve and the branching portion in the discharge passage and constricts a flow passage cross-sectional area of the discharge passage. According to the present disclosure, the discharge passage orifice is placed on the upstream side of the relief valve at the location between the discharge valve and the branching portion in the discharge passage, so that the sufficient relief flow rate of the fuel from the fuel rail can be ensured, and the pressure pulsation of the pressure immediately before the relief valve can be appropriately limited. As a result, a peak pressure of the pressure pulsation is reduced, and thereby the valve opening pressure of the relief valve can be set to a required minimum value.

Furthermore, in the previously proposed technique of the patent literature 1, the orifice, which stabilizes the amount of fuel injection at the fuel injection valve by limiting the pressure pulsation of the fuel rail, needs to be formed at the inlet of the fuel rail besides the constriction located on the upstream side of the relief valve. In contrast, according to the present disclosure, since the pressure pulsation of the fuel rail is limited by the discharge passage orifice, the orifice at the inlet of the fuel rail can be eliminated.

In the present disclosure, the return portion, to which the relief passage on the downstream side of the relief valve is merged, may be located in a low-pressure region that is placed on an upstream side of a suction valve with respect to the flow of the fuel. The suction valve is placed on a side of the pressurizing chamber where the suction passage is placed, and the suction valve is closed to limit backflow of the fuel at a time of pressurizing the fuel in the pressurizing chamber. Alternatively, the return portion may be located in a high-pressure region that is placed between the suction valve and the discharge valve.

### BRIEF DESCRIPTION OF DRAWINGS

FIG. 1 is a schematic diagram showing a structure of a fuel supply apparatus, in which a high-pressure pump according to a first embodiment of the present disclosure is applied.

FIG. 2(a) is a diagram showing pressure pulsation of a pressure immediately before a relief valve in a high-pressure pump of a comparative example, and FIG. 2(b) is a diagram showing pressure pulsation in the high-pressure pump according to the embodiment of the present disclosure.

FIG. 3 is a schematic diagram showing a structure of another fuel supply apparatus, in which a high-pressure pump according to the first embodiment of the present disclosure is applied.

FIG. 4 is a schematic diagram showing a structure of a fuel supply apparatus, in which a high-pressure pump according to a second embodiment of the present disclosure is applied.

FIG. 5 is a schematic diagram showing a structure of another fuel supply apparatus, in which a high-pressure pump according to the second embodiment of the present disclosure is applied.

FIG. 6 is a schematic diagram showing a structure of a fuel supply apparatus, in which a high-pressure pump according to a third embodiment of the present disclosure is applied.

FIG. 7 is a schematic diagram showing a structure of a previously proposed fuel supply apparatus.

### DESCRIPTION OF EMBODIMENTS

Hereinafter, a high-pressure pump of a plurality of embodiments of the present disclosure will be described with reference to the accompanying drawings. In the following embodiments, the substantially identical structures will be indicated by the same reference signs and will not be redundantly described for the sake of simplicity.

### First Embodiment

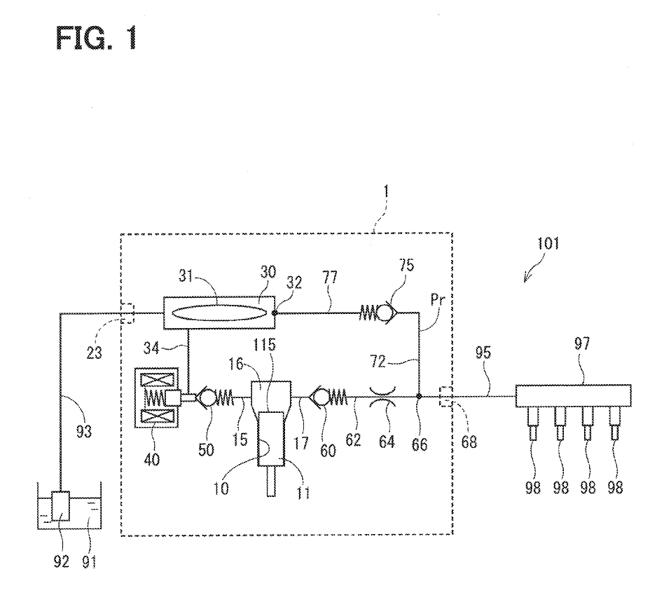

A structure of a fuel supply apparatus, to which a high-pressure pump according to a first embodiment of the present disclosure is applied, will be schematically described with reference to FIG. 1. The fuel supply apparatus 101 includes a fuel tank 91, a low-pressure pump 92, the high-pressure pump 1, a fuel rail 97 and fuel injection valves 98.

Fuel of the fuel tank 91 is supplied by the low-pressure pump 92 to the high-pressure pump 1 through a low-pressure pipe 93. The high-pressure pump 1 pressurizes the fuel, which is supplied from the fuel tank 91, and the high-pressure pump 1 discharges the pressurized fuel to the fuel rail 97 through a high-pressure pipe 95. The fuel rail 97 accumulates the high-pressure fuel, which is discharged from the high-pressure pump 1. Each of the fuel injection valves 98 is connected to the fuel rail 97 and injects the high-pressure fuel, which is accumulated in the fuel rail 97, into a corresponding one of cylinders of an engine (not shown). In an example shown in FIG. 1, four fuel injection valves 98, which correspond to a four-cylinder engine, are connected to the fuel rail 97.

The high-pressure pump 1 includes a cylinder 10, a plunger 11, a pulsation damper 31, a solenoid valve 40, a suction valve 50, a discharge valve 60, and a relief valve 75 as its main components.

The cylinder 10 reciprocatably receives the plunger 11. A pressurizing chamber 16 is formed in an upper bottom portion of the cylinder 10. The pressurizing chamber 16 faces a pressurizing end 115 of the plunger 11, which is one end of the plunger 11, and the fuel is pressurized in the pressurizing chamber 16 at the time of upward movement of the plunger 11. A suction passage 15 is formed on the suction valve 50 side of the pressurizing chamber 16, and a discharge passage 17 is formed on the discharge valve 60 side of the pressurizing chamber 16.

The high-pressure pump 1 is installed to an engine block (not shown). When reciprocation of a tappet, which is reciprocated in response to rotation of a camshaft, is transmitted to the plunger 11, the plunger 11 is reciprocated from a top-dead center to a bottom-dead center in the cylinder 10. Thereby, a volume of the pressurizing chamber 16 is periodically changed, and the high-pressure pump 1 repeats a suction stroke, a metering stroke, and a discharge stroke.

In the suction stroke, the plunger 11 is moved downward toward the bottom-dead center, so that the fuel is drawn into the pressurizing chamber 16. In the metering stroke, the plunger 11 is moved upward to a transition point, which is located between the bottom-dead center and the top-dead center, while a portion of the fuel drawn into the pressurizing chamber 16 is returned to the upstream side. In the discharge stroke, the plunger 11 is moved from the transition point toward the top-dead center, so that the fuel in the pressurizing chamber 16 is pressurized and is discharged from the pressurizing chamber 16.

Hereinafter, the construction of the high-pressure pump 1 will be described from the upstream side to the downstream side in a flow direction of the fuel.

The low-pressure fuel, which is received from the fuel tank 91, flows from a fuel inlet 23 into a damper chamber 30, in which the pulsation damper 31 is placed. The pulsation damper 31 is formed with two diaphragms, which are joined together along outer peripheral edges thereof. A gas of a predetermined pressure is sealed in a sealed space in an inside of the pulsation damper 31. The pulsation damper 31 damps pressure pulsation of the fuel in the damper chamber 30 through resilient deformation of the pulsation damper 31 in response to a change in the fuel pressure in the damper chamber 30.

Furthermore, in the first embodiment, a return portion 32, which will be described later, is formed at the damper chamber 30, which serves as a low-pressure region located on the upstream side of the suction valve 50 with respect to a flow of the fuel. The damper chamber 30 serves as a fuel chamber of the present disclosure, to which the return portion 32 merges.

The solenoid valve 40 opens or closes the suction valve 50 through attraction of a movable core with a magnetic attractive force that is generated through energization of a coil. For example, in case of a normally open type structure, the suction valve 50 is opened at the time of not energizing the coil, so that the suction valve 50 communicates between a communication passage 34, which is communicated with the damper chamber 30, and the suction passage 15, which is located on the upstream side of the pressurizing chamber 16. When the coil is energized, the suction valve 50 is closed to block the communication between the communication passage 34 and the suction passage 15.

At the time of operating the high-pressure pump 1, the timing for energizing the solenoid valve 40 is controlled such that the suction valve 50 is opened in the suction stroke and the metering stroke, and the suction valve 50 is closed in the discharge stroke. In the discharge stroke, the suction valve 50 is closed to prevent backflow of the fuel to the damper chamber 30 at the time of pressurizing the fuel in the pressurizing chamber 16.

In the discharge passage, which communicates between the pressurizing chamber 16 and a discharge outlet 68, the discharge valve 60 is placed between the discharge passage 17 at the pressurizing chamber 16 side (before the discharge valve) and a discharge passage 62 at the discharge outlet 68 side (after the discharge valve). The discharge valve 60 can be opened to enable flow of the fuel from the pressurizing chamber 16 to the discharge outlet 68 in response to a fuel pressure difference between the pressurizing chamber 16 side of the discharge valve 60 and the discharge outlet 68 side of the discharge valve 60.

In the suction stroke and the metering stroke, in each of which the fuel pressure of the pressurizing chamber 16 is relatively low, for instance, a valve element of the discharge valve 60 is seated against a valve seat by an urging force of a spring and a force exerted by a pressure of the fuel rail 97, and thereby the discharge valve 60 is closed to stop discharge of the fuel. When the fuel pressure of the pressurizing chamber 16 is increased in the discharge stroke, for instance, the valve element is lifted away from the valve seat against the sum of the urging force of the spring and the force exerted by the pressure of the fuel rail 97, and thereby the discharge valve 60 is opened to discharge the high-pressure fuel, which is pressurized in the pressurizing chamber 16, from the discharge outlet 68 to the fuel rail 97.

A branching portion 66, which is branched to a relief passage 72, is formed in the discharge passage 62 at a location, which is on the discharge outlet 68 side of the discharge valve 60, i.e., on the downstream side of the discharge valve 60.

Furthermore, a discharge passage orifice 64, which constricts a cross-sectional area of the discharge passage 62, is formed in the discharge passage 62 at a location, which is between the discharge valve 60 and the branching portion 66. The formation of the discharge passage orifice 64 on the upstream side of the branching portion 66 in the discharge passage 62 is a characteristic structure of the present disclosure.

In the relief passage that communicates between the branching portion 66 and the return portion 32, the relief valve 75 is placed between the relief passage 72 at the branching portion 66 side (before the relief valve) and the low-pressure relief passage 77 at the return portion 32 side (after the relief valve). The relief valve 75 can be opened to enable the flow of the fuel from the branching portion 66 side to the return portion 32 side in response to a fuel pressure difference between the branching portion 66 side (i.e., the fuel rail 97 side) of the relief valve 75 and the return portion 32 side of the relief valve 75.

A valve opening pressure of the relief valve 75 is set such that the relief valve 75 opens when the fuel pressure of the fuel rail 97 is increased beyond a predetermined value that is an upper limit of a normal range of the fuel pressure of the fuel rail 97. In the first embodiment, since the damper chamber 30, which is the low-pressure region, is located at the merging location of the return portion 32, the influence of the return portion 32 side fuel pressure on the valve opening pressure of the relief valve 75 is relatively small. Therefore, the valve opening pressure of the relief valve 75 is determined substantially by an urging force of a spring of the relief valve 75.

In a state where the fuel pressure of the fuel rail 97 is equal to or lower than the predetermined value in the normal time, for instance, a valve element of the relief valve 75 is seated against a valve seat by the urging force of the spring of the relief valve 75 and the force exerted by the pressure of the damper chamber 30. In contrast, when the fuel pressure of the fuel rail 97 is increased beyond the predetermined value due to, for example, valve malfunction or temperature increase abnormality, for instance, the valve element of the relief valve 75 is lifted away from the valve seat against the urging force of the spring of the relief valve 75 and the force exerted by the pressure of the damper chamber 30, and thereby the relief valve 75 is opened to return the fuel of the excessive pressure of the fuel rail 97 to the return portion 32 through the relief passages 72, 77.

Hereinafter, the fuel pressure of the relief passage 72 will be referred to as “a pressure Pr immediately before the relief valve 75”. The reciprocation of the plunger 11 results in pressure pulsation of the pressure Pr immediately before the relief valve 75 that is communicated to the discharge passage 62. Therefore, the valve opening pressure of the relief valve 75 needs to be set to a value that limits opening of the relief valve 75 even at a peak pressure of the pressure Pr immediately before the relief valve 75.

In the embodiment of the present disclosure, the pressure pulsation of the pressure Pr immediately before the relief valve 75 is limited by forming the discharge passage orifice 64 in the discharge passage 62. The effect and advantage of this configuration will be described later.

The structures of the fuel supply apparatus 101 and the high-pressure pump 1 have been described with reference to FIG. 1. Since FIG. 1 is the schematic diagram, the relationship with the real structure will be supplementarily described.

In FIG. 1, the fuel passage, which connects one side and the other side, is indicated by a single straight line. The fuel passage is not necessarily in the straight form and may be formed by a plurality of passages.

The suction valve 50, the discharge valve 60 and the relief valve 75 are check valves, each of which enables flow of the fuel in one direction and blocks backflow of the fuel in an opposite direction that is opposite from the one direction. Each of these check valves should not be limited to the one that is shown in the drawing and includes the ball valve element and the spring and may be alternatively formed by a valve element of any shape and an urging means. Furthermore, the discharge valve 60 and the relief valve 75 may be respectively formed as any valve that has the function of opening the valve when a pressure difference between the one side and the opposite side of the valve becomes equal to or higher than the predetermined value.

The discharge passage orifice 64 may be in any form as long as the discharge passage orifice 64 constricts the flow passage cross-sectional area of the discharge passage 62. For example, an orifice, which has a smaller inner diameter in comparison to the discharge passage 62, may be formed in a center of a cross section of the discharge passage 62 that is shaped into, for example, a circle. Alternatively, as recited in the patent literature 1 (JP2004-197834A), the orifice may be formed by a gap that is shaped into an annular form and is located between a tube and a shaft.

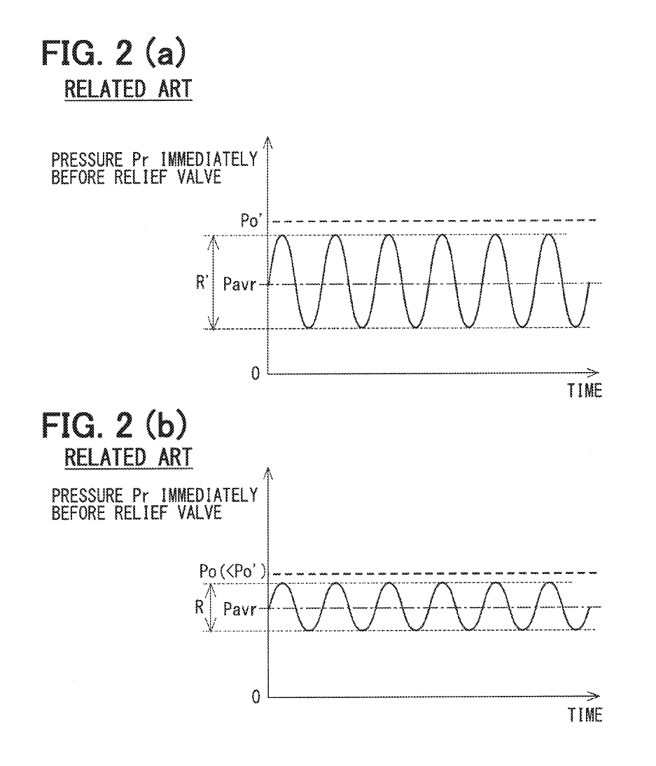

Next, the objective of the present disclosure and the advantages of the embodiment of the present disclosure will be described with reference to FIGS. 2(a) and 2(b) through comparison with the previously proposed technique and a comparative example,

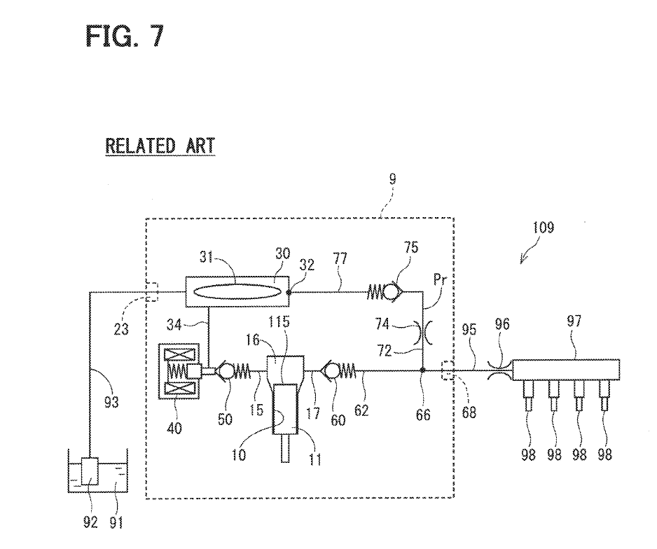

A fuel supply apparatus 109 shown in FIG. 7 has a structure, which corresponds to the previously proposed technique of the patent literature 1 and is indicated in a manner that corresponds to the structure of the first embodiment shown in FIG. 1. In a high-pressure pump 9 of FIG. 7, a relief passage orifice 74 is formed in the relief passage 72 located between the branching portion 66 and the relief valve 75 to reduce the pressure pulsation of the pressure Pr immediately before the relief valve 75. Specifically, it is intended to reduce the influence of the pressure pulsation, which is generated by the reciprocation of the plunger 11, on the relief valve 75.

Furthermore, a rail-upstream-side orifice 96 is formed at an inlet of the fuel rail 97 to limit the pressure pulsation of the fuel at the fuel rail 97 and to stabilize the amount of fuel injection at the fuel injection valves 98.

However, in the previously proposed technique of the patent literature 1, the flow of the fuel from the relief passage 72 to the relief passage 77 through the relief valve 75 is interfered by the relief passage orifice 74. Thereby, a sufficient relief flow rate of the fuel from the fuel rail 97 cannot be ensured at the time of increasing the fuel pressure of the fuel rail 97.

Therefore, it is the objective of the embodiment of the present disclosure to ensure the sufficient relief flow rate of the fuel from the fuel rail 97 and to reduce the pressure pulsation of the pressure Pr immediately before the relief valve 75.

As shown in FIG. 1, in comparison to the previously proposed technique of the patent literature 1, in the embodiment of the present disclosure, instead of forming the relief passage orifice 74 in the relief passage 72 on the downstream side of the branching portion 66, the discharge passage orifice 64 is formed between the discharge valve 60 and the branching portion 66 in the discharge passage 62. Therefore, since the cross-sectional area of the flow passage from the fuel rail 97 to the relief valve 75 through the branching portion 66 and the relief passage 72 is not constricted, the sufficient relief flow rate of the fuel can be ensured.

Next, FIG. 2(a) indicates pressure pulsation of the fuel in a comparative example, in which an orifice is not formed in the discharge passage 62 and the relief passage 72. FIG. 2(b) indicates the pressure pulsation of the pressure Pr immediately before the relief valve 75 in the embodiment of the present disclosure. An amplitude R of the pressure pulsation in the embodiment of the present disclosure is smaller than an amplitude R′ of the pressure pulsation of the comparative example. In a case where an average pressure Pavr is the same between the embodiment of the present disclosure and the comparative example, a peak pressure is reduced in the embodiment of the present disclosure in comparison to the comparative example. Thereby, a valve opening pressure Po, which is set to be slightly higher than the peak pressure, can be set to be lower than the valve opening pressure Po' of the comparative example.

In the case where the valve opening pressure Po' can be set to be lower, the valve opening pressure of the fuel injection valve 98 can be limited, and a required pressure resistance of components used for the high-pressure region of the fuel supply apparatus 101 can be reduced. Thus, the reliability of the fuel supply apparatus 101 can be improved while the component costs of the fuel supply apparatus 101 are reduced.

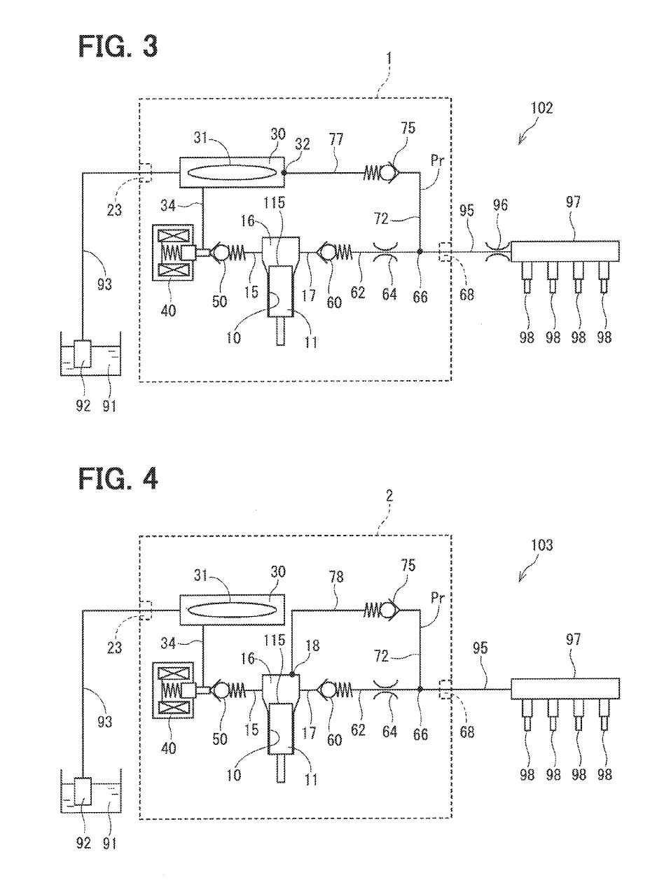

Furthermore, in the embodiment of the present disclosure, the discharge passage orifice 64 is provided in the discharge passage 62, so that the discharge passage orifice 64 can also have the function of the rail-upstream-side orifice 96 of the previously proposed technique. Thus, the rail-upstream-side orifice 96 can be eliminated like in the case of the fuel supply apparatus 101 shown in FIG. 1. Alternatively, as in a case of a fuel supply apparatus 102 shown in FIG. 3, the high-pressure pump 1 of the embodiment of the present disclosure may be applied, and a rail-upstream-side orifice 96 may be formed at the inlet of the fuel rail 97.

### Second Embodiment

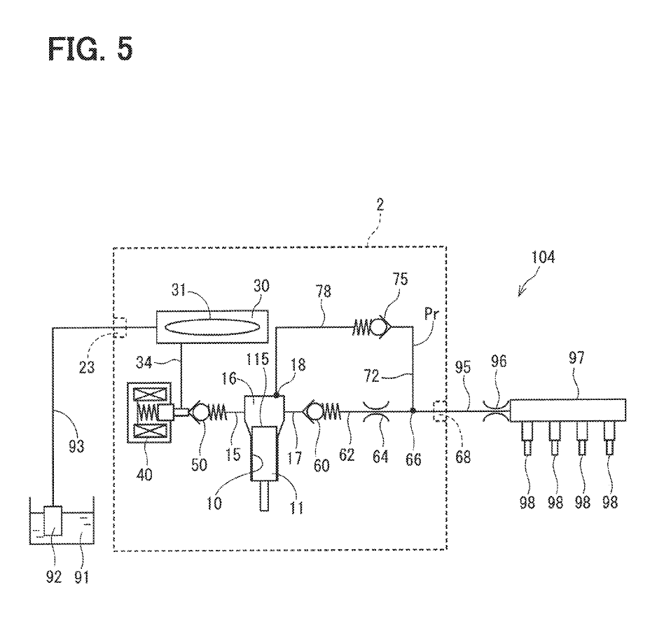

Next, a schematic structure of a fuel supply apparatus, in which a high-pressure pump of a second embodiment is applied, will be described with reference to FIGS. 4 and 5. A difference between FIG. 4 and FIG. 5 is that the rail-upstream-side orifice 96 is present or absent. FIG. 4 indicates a fuel supply apparatus 103, in which the rail-upstream-side orifice 96 is absent and corresponds to FIG. 1 of the first embodiment. FIG. 5 indicates a fuel supply apparatus 104, in which the rail-upstream-side orifice 96 is present and corresponds to FIG. 3 of the first embodiment.

A high-pressure pump 2 of the second embodiment differs from the first embodiment with respect to that the relief passage 78 on the downstream side of the relief valve 75 is merged with the pressurizing chamber 16 instead of the damper chamber 30. Specifically, in the second embodiment, a return portion 18 is formed at the pressurizing chamber 16, which is the high-pressure region located between the suction valve 50 and the discharge valve 60. In order to distinguish the relief passage 78 of the second embodiment from the low-pressure relief passage 77 of the first embodiment, the relief passage 78 of the second embodiment will be referred to as a high-pressure relief passage 78. The pressurizing chamber 16 serves as a fuel chamber of the present disclosure, to which the return portion 18 is merged.

The relief valve 75 of the second embodiment differs from the relief valve 75 of the first embodiment with respect to that the pressure of the high-pressure relief passage 78 changes in response to the reciprocation of the plunger 11. However, similar to the relief valve 75 of the first embodiment, the relief valve 75 of the second embodiment has the advantage of reducing the pressure pulsation of the pressure Pr immediately before the relief valve 75 while ensuring the sufficient relief flow rate of the fuel. Thus, the valve opening pressure of the relief valve 75 can be set to a required minimum value.

Furthermore, the discharge passage orifice 64 can limit the pressure pulsation of the fuel rail 97, so that as shown in FIG. 4, the rail-upstream-side orifice 96 can be eliminated.

However, as shown in FIG. 5, the rail-upstream-side orifice 96 may be provided.

### Third Embodiment

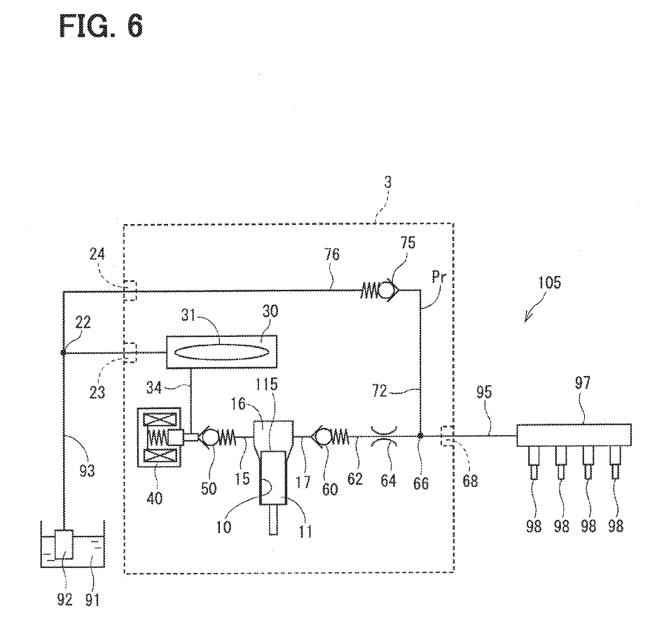

Next, a schematic structure of a fuel supply apparatus, in which a high-pressure pump of a third embodiment is applied, will be described with reference to FIG. 6. As shown in FIG. 6. the fuel supply apparatus 105 has the return portion 22 in the middle of the low-pressure pipe 93 at the outside of the high-pressure pump 3. A relief passage 76 extends from the downstream side of the relief valve 75 to the return portion 22 through a return connection 24 formed in the high-pressure pump 3. The low-pressure pipe 93 serves as a fuel chamber of the present disclosure, to which the return portion 22 merges.

The return portion, which is formed on the upstream side of the suction valve 50 with respect to the flow of the fuel, should not be limited to the return portion formed in the inside of the high-pressure pump 1 like in the first embodiment and may be formed at the outside of the high-pressure pump 3. Even in this embodiment, advantages, which are similar to those of the first embodiment, can be achieved.

### Other Embodiments

(1) As discussed above, the high-pressure pump of the present disclosure is specified such that the high-pressure pump includes the plunger, the cylinder, the discharge valve and the relief valve, and the high-pressure pump has the discharge passage orifice on the upstream side of the relief valve at the location, which is between the discharge valve and the branching portion in the discharge passage. The specific form of the respective constituent components discussed above and the other constituent component(s) are not specified with respect to the high-pressure pump of the present disclosure. For example, the structures and the forms of the discharge valve and the relief valve, the locations of the discharge passage, the relief passage and the branching portion, and the size of the cross-sectional area and the length of the discharge passage orifice may be appropriately set in any manner.

(2) The location of the return portion, at which the relief passage is merged to the fuel chamber, should not be limited to the location depicted in the drawings of the above embodiments. The configuration of the first embodiment, in which the return portion is formed in the inside of the high-pressure pump 1 on the upstream side of the suction valve 50 with respect to the flow of the fuel, may be implemented such that the low-pressure relief passage 77 merges to a location immediately after the fuel inlet 23 or to the communication passage 34. Furthermore, the configuration of the second embodiment, in which the return portion is formed between the suction valve 50 and the discharge valve 60, may be implemented such that the high-pressure relief passage 78 is merged with the suction passage 15 or a portion of the discharge passage 17 before the discharge valve.

The present disclosure should not be limited to the above embodiments and may be embodied in various other ways without departing form the principle of the present disclosure.

1. A high-pressure pump comprising:
a plunger;
a cylinder that reciprocatably receives the plunger and forms a pressurizing chamber, which faces one end of the plunger and pressurizes fuel;
a discharge valve that is placed in a discharge passage, which communicates between the pressurizing chamber and a discharge outlet, wherein the discharge valve is openable to enable flow of the fuel from the pressurizing chamber to the discharge outlet in response to a fuel pressure difference between the pressurizing chamber side and the discharge outlet side;
a relief valve that is placed in a relief passage, wherein the relief passage communicates between a branching portion, which is located on a side of the discharge valve where the discharge outlet is placed in the discharge passage, and a return portion, which merges with a fuel chamber at a location that is on an upstream side of the discharge valve with respect to a flow of the fuel, and the relief valve is openable to enable flow of the fuel from the branching portion to the return portion in response to a fuel pressure difference between the branching portion side and the return portion side; and
a discharge passage orifice that is placed between the discharge valve and the branching portion in the discharge passage and constricts a flow passage cross-sectional area of the discharge passage.

2. The high-pressure pump according to claim 1, further comprising a suction valve that is placed on a side of the pressurizing chamber where the suction passage is placed, wherein:
the suction valve is closed to limit backflow of the fuel at a time of pressurizing the fuel in the pressurizing chamber; and
the return portion is located on an upstream side of the suction valve with respect to the flow of the fuel.

3. The high-pressure pump according to claim 2, wherein the return portion is placed in an inside of the high-pressure pump.

4. The high-pressure pump according to claim 1, further comprising a suction valve that is placed on a side of the pressurizing chamber where the suction passage is placed, wherein:
the suction valve is closed to limit backflow of the fuel at a time of pressurizing the fuel in the pressurizing chamber; and
the return portion is placed between the suction valve and the discharge valve.
